(19) United States
(12) Patent Application Publication
(10) Pub. No.: US 2026/0106422 A1
(43) Pub. Date: Apr. 16, 2026

(54) MULTI-CIRCUITED MODULAR WIRING POWER SPLITTER FOR POWERING A DEVICE REQUIRING ISOLATED EMERGENCY POWER AND HOUSE POWER INPUTS

(71) Applicant: Exposure Illumination Architects, Inc., Scottsdale, AZ (US)

(72) Inventor: Daniel S. SPIRO, Scottsdale, AZ (US)

(73) Assignee: Exposure Illumination Architects, Inc., Scottsdale, AZ (US)

(21) Appl. No.: 18/912,942

(22) Filed: Oct. 11, 2024

(51) Int. Cl. H01R 31/02; H01B 9/00

(52) U.S. Cl. CPC H01R 31/02; H01B 9/006

(57) ABSTRACT

A trimming tool is used to help in the installation of a suspended device, such as a luminaire. The tool is used for suspending, plumbing, and trimming a device coupled at a specified mounting elevation by a suspension cable coupled to two support mounting points above The tool includes an elongated horizontal structure with vertical extension members positioned at the elongated horizontal structure opposite ends, wherein the vertical extensions terminate at each end with a substantially horizontal tab. The tool also includes a depressible bar, a latching device, and a suspension cable coupled to at least two couplers that are mounted to a device below.

### CROSS-REFERENCE TO RELATED APPLICATIONS

The present application contains subject matter related to U.S. Pat. Nos. 11,573,005, 11,629,852, 11,788,692, and 11,988,357, the entire contents of each of which being incorporated herein by reference.

### BACKGROUND

### Technical Field

The present disclosure relates to modular wiring systems that provide emergency power, as well as non-emergency power to power consuming devices, such as lighting system in a retail warehouse space.

### Discussion of Background

A modular wiring system (MWS) is commonly used in buildings for lighting and data connectivity. MWS benefits include faster construction production and less chance of mis-wiring by the installing contractor. Encased in a protective covering, the MWC's conductors are fabricated in accordance with engineering plans, coupled to their connectors. In essence, the conventional MWS assembly includes plug-n-play modular components that at one end receive power from a power source and at the other end connect to at least one power consuming device. As recognized by the present inventor, disadvantages of the conventional MWS include higher material cost and less flexibility when engineers revise submitted electrical plans.

The conventional MWS includes a starter cable, extender cables, splitters, and drop cables or cords. With some MWSs that are more synonymous with data conveyance, distribution boxes can also be used in conjunction with the MWS.

Among the most important characteristics of the MWS is the system's code approved wiring method that is regulated and in conformance with specific regulatory agency standards. As a closed system, the MWS connectors are keyed for specific voltages and are limited to maximum voltage capacity. Within this closed system, the number of conductors is limited to the number of receptacle connectors that connect one modular wiring cable to another.

The current US electrical building code allows for ambient power conductors and egress emergency lighting power conductors to be conveyed inside cabling of the MWS. The code requires that any power conductors conveying power to building devices that operate under emergency power must be encased in armored, protected coverings that withstand fire to a minimum code mandated duration.

Present day lighting devices commonly employ LED light sources. The LED light source is becoming more efficient yearly. As a result, the LED light source size is becoming smaller. Today's ambient light source can include an egress light source in a single device. The egress light source size can be small, its lumen output can outperform legacy light sources, and its power consumption is significantly less than legacy light sources. While today's ambient light source with a coupled egress light source form can be reduced, the integral batteries' form has not kept up with other technological advances. Today's ambient lighting luminaire with a reduced form egress light source can include a back-up battery power source; however, it is more desirable to use remote power sources such as inverters.

As will be discussed below, as compared to conventional MWSs, the present disclosure describes a less costly, faster to install, code compliant integrated power distribution solution for at least one embodiment of ambient and emergency egress lighting/signage system by using modular wiring cabling that is configured to receive back-up power from a remote source.

### SUMMARY

The focus of the present disclosure is on a new Modular Wiring System (MWS) component that couples to at least one building light emitting device. More specifically, at least one conductor of the MWS is configured to convey emergency back-up remote power through a component referred to herein as the Power Type Splitter (PTS) to the at least one downstream emergency/ambient light emitting device.

While the current US electrical building code allows for back-up emergency remote power conductors to be conveyed alongside non-emergency power conductors inside an armored MWS cables, the US fire code mandates separation between conductors' power source types at the power receiving end where the MWS cable couples the emergency/ambient light emitting device. In accordance with the NFPA 700.10 (B) (2) the emergency power conductor/s and the non-emergency power conductor/s must be separated from one another and access the emergency/ambient light source through dedicated ports.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGS. 1a and 1b show modular wiring systems commonly used in the North American building construction industry.

FIG. 2 shows a frontal view of the Power Type Splitter (PTS) of the present innovation.

FIGS. 3a and 3b show exemplary enlarged embodiments of the PTS with an integrated emergency PTS cable and an integrated non-emergency PTS cord, respectively.

FIGS. 4a and 4b show enlarged views of the PTS including a PTS with a double-sided plug connectivity and a PTS with a double-sided plug connectivity and an integrated drop cable.

FIGS. 5a, 5b, 5c, and 5d show the PTS and reciprocating cable and cord plugs' means of electrical connectivity.

FIGS. 6a and 6b show exemplary PTS connectors configured to convey two and three circuits' power to a downstream device respectively.

FIG. 7 shows a perspective view of an assembly of light emitting devices electrically coupled by modular wiring with circuits conveying emergency and non-emergency power.

### DETAILED DESCRIPTION

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

The present disclosure describes keyed connectors for at least one starter cable 45, an extender cable 8, a connector 19 that couples to an extender cable, a phase splitter 40, a drop cable 13, a PTS 3, a PTS drop cable 6, and a PTS drop cord 7. Notably, the present innovation MWS varies from conventional MWSs in various ways. For a conventional MWS, drop cord 11 or the drop cable 14 is coupled at one end to an extender cable 8 or a phase splitter 40 and on the other end is coupled to a light emitting device 35, wherein the cord or the cable convey power to a light emitting device 35 from a single power type source. The MWS of the present disclosure conveys power to an emergency/ambient light source 26 from two different power type sources.

The present MWS 50 employs keyed connectors 19. Connectors 19 can be configured to key only to conductors 2 that have at least one of the same operational voltage range, and the same power type usage. For example, a 120V keyed connector 19 shall not connect to a 480V keyed connector 19. For another example, a conductor 2 flowing 120V back-up emergency power through a keyed connector 19 can be configured to not be able to make electrical contact with a conductor 2 that flows 480V house power through a keyed connector 19.

The keyed connector of a building emergency illuminated means of egress can be configured to at least receive power for emergency egress light sources and emergency egress signs. At least two circuits of emergency remote back-up power can be conveyed inside the MWS 50, wherein at least one circuit can be under load continuously, while the other circuit can be put under load only when house power is interrupted. The circuit under constant load can power building emergency egress signage devices. The circuit that is powered when house power is interrupted can power at least light sources that illuminate a building egress path. In addition, the present innovation can also flow power through a third power circuit to a non-emergency power consuming device.

The present disclosure also describes a MWS that permit power to flow to at least two circuits, wherein one circuit power originates from a back-up emergency power source while the other circuit power originates from house power. Both circuits convey the power side by side inside one MWS 50 cable. To comply with prevailing building code/s, the present innovation shows and teaches of a power type splitter (PTS) 3 that couples a drop cable 13 at the power receiving side, and couples at least one other side to at least one of, a PTS drop cable 6, a PTS drop cord 7, an integrated emergency PTS cable 17, and an integrated non-emergency PTS cord 18. Selected properties of the present disclosure include:
A code and regulatory agency approved modular wiring assembly with conductors that convey power to building emergency egress means of illumination and at least one other power consuming device.
A modular wiring assembly wherein at least one cable conveying power to a building emergency illuminated means of egress is coupled to a light emitting device through a dedicated port and at least one cord and/or cable conveying non-emergency powered to the same light emitting device enters the same device through at least one different port.
A modular wiring assembly conveying power to building emergency illuminated means of egress and power to building non-emergency power consuming device/s wherein at least one key of a receptacle of a power type splitter that conveys power to building emergency illuminated means of egress is configured differently from the power type splitter keyed receptacle that conveys power to a non-emergency powered device.
A modular wiring system assembly wherein at least one exterior surface of an assembly component that conveys emergency power to a building means of illuminated egress is colored differently from the balance of the assembly.
A modular wiring system assembly wherein at least one pinned conductor conveying power to a downstream device is last to electrically engage inside a power type splitter pin opening and first to break load when disengaged.
A modular wiring system assembly comprising at least one power type splitter wherein at least one surface of the power type splitter is configured to couple to a PTS emergency power drop cable or non-emergency power drop cord.
The modular wiring system comprising at least one power type splitter wherein the power type splitter is coupled at one surface to a drop cable and at another surface coupled to at least one of an integrated emergency PTS cable and an integrated non-emergency PTS drop cord.
A modular wiring system assembly configured to convey power to building emergency illuminated means of egress and power to non-emergency power consuming devices comprising at minimum five conductors further comprising a first power circuit with a neutral conductor, a second power circuit with a neutral conductor, and a single common ground conductor.
A six conductor modular wiring assembly configured to power building emergency illuminated means of egress and power non-emergency power consuming devices, the assembly further comprising three circuits where the first circuit has a dedicated neutral conductor, the second and the third circuit have a common neutral conductor, and all three circuits share a ground conductor.
The modular wiring assembly having at least two circuits conveying power to a building emergency illuminated means of egress wherein a circuit can be continuously under load while the at least one other circuit is configured to be under load when house power is interrupted.
The modular wiring assembly wherein a starter cable with a connector couple to a phase splitter.
The modular wiring system assembly wherein keyed connectors prevent coupling an emergency power connector with a non-emergency power connector.
The modular wiring system wherein keyed connectors prevent coupling cables and/or cords that flow different range voltages.
The modular wiring system assembly wherein the power type splitter comprises at least one mechanical fastener and/or a mechanical fastener receiver that is/are configured to prevent at least one coupled PTS cable or PTS cord plug disconnection.
The modular wiring system wherein the circuit that is continuously under load is configured to power at least one building egress sign.
The modular wiring system wherein the emergency lighting circuit that is not under constant load is configured to at least power at least one egress light luminaire that illuminates a path of egress.
The modular wiring system wherein the circuit receiving constant power to illuminate the building egress signage is coupled to a power storage device.
The modular wiring system wherein the same circuit power is split inside the PTS with provisions for at least two output ports for at least one of a PTS drop cable or PTS drop cord connectivity.
The modular wiring system wherein at least one first power circuit powers an exit sign, one second power circuit powers an egress light source, and one third power circuit powers an ambient lighting luminaire.

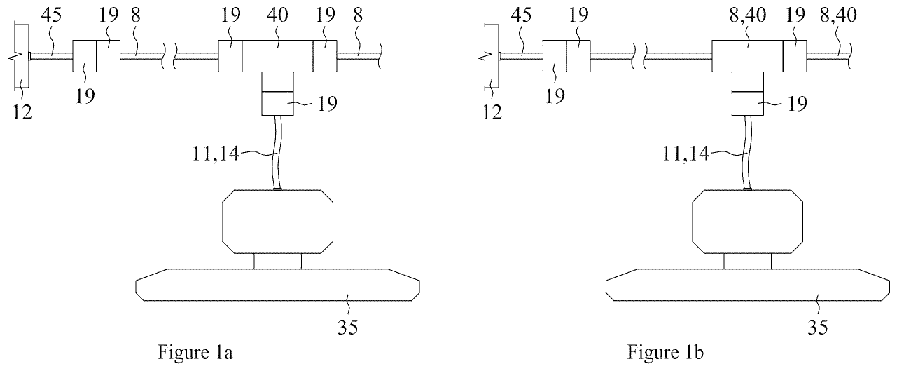

FIGS. 1a and 1b show modular wiring systems commonly used in the North American building construction industry.

FIG. 1a shows a modular wiring system having a power source 12, a starter cable 45, extender cables 8, a phase splitter 40, and a drop cord 11 (or drop cable 14, not shown) coupled to a light emitting device 35. It is noted that the entire modular wiring assembly connects by employing keyed connectors 19. The keyed connectors assure continuous power connectivity between the modular system cables, maintaining the integrity of the system circuits as configured. The connectors are configured to enable the connectivity of compatible voltage modular components.

FIG. 1b shows a modular wiring system having a power source 12, a starter cable 45, extender cables 8 that couple at least one phase splitter 40 at one end of the cable, and a drop cord 11 (or drop cable 14, not shown) coupled to a light emitting device 35. It is noted that the entire modular wiring assembly connects by employing keyed connectors 19. The keyed connectors 19 assure continuous power and mechanical connectivity between the system's modular cables while maintaining the integrity of the system circuits as configured. Connectors 19 are configured to allow connectivity to only voltage compatible modular wiring components.

The above systems shown are similar to one another, with the exception of the extender cable 8 architecture. Other elements (not shown) can be incorporated into this present base architecture of the modular wiring system, as shown. Their addition has no bearing on the present innovation.

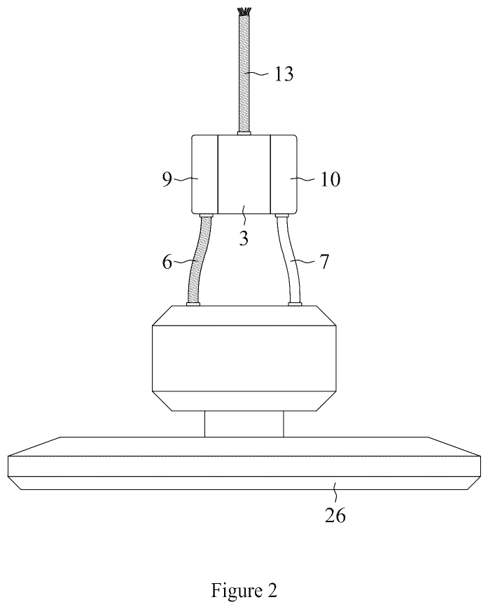

FIG. 2 shows a frontal view of the Power Type Splitter (PTS) of the present disclosure. This PTS is not used in conventional MWSs.

The PTS 3 (FIG. 2) shown is electrically coupled to a light emitting device configured to provide emergency egress lighting and ambient lighting 26. The PTS 3 of the present embodiment receives through the PTS 3 drop cable 13 emergency back-up power and house power. The conductors of the two power type sources inside the PTS 3 couple to receptacles that are exposed to the exterior (not shown). At one end, the PTS emergency power drop cable 6 is shown coupled to the emergency/ambient light emitting device 26. At the other end, the PTS emergency power drop cable 6 is shown coupled to an emergency drop cable plug 9. The plug 9 is shown coupled to the emergency power female plug receptacle of the PTS 3 (not shown).

At the opposite side of the PTS 3, a PTS non-emergency power drop cord 7 is shown coupled to the emergency/ambient light emitting device 26. At the other end, the cord couples a non-emergency drop cable plug 10. The plug 10 is shown coupled to the non-emergency power female plug receptacle of the PTS 3 (not shown).

It is noted that these cables or cable and cord are separated and isolated from one another as they are received inside the emergency/ambient light emitting device 26. It is also noted that the PTS 3 can be configured to couple to more than one PTS drop cable and/or cord. These cables can be fixed and/or detachable. The coupled PTS drop cables/cords can include at least one cable 6 with an armored exterior that is fire rated and at least one cord 7 with non-armored exterior insulation or an armored exterior.

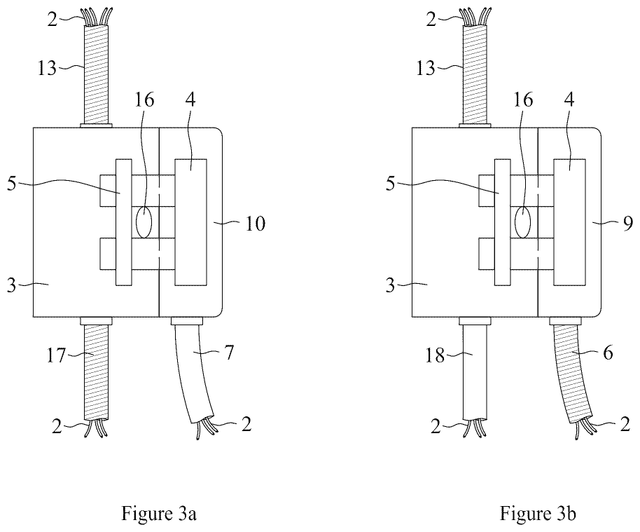

FIGS. 3a and 3b show exemplary enlarged embodiments of the PTS with an integrated emergency PTS cable and an integrated non-emergency PTS cord, respectively.

FIG. 3a, an enlarged view, shows a PTS drop cable 13 coupled to the PTS 3 from above. An integrated emergency PTS cable 17 is shown coupled to the PTS 3 from below. From the side, a non-emergency drop cord 7 with a non-emergency drop cord plug 10 is shown coupled to the PTS 3. At least one non-emergency drop cable plug 10 can have a fastener 4 coupled thereto. This fastener can be configured to mechanically engage a reciprocating fastener receiver 5 that is coupled to the PTS 3. In at least one different embodiment, at least one fastener 4 can be coupled to the body of the PTS 3 and can be configured to mechanically engage at least one fastener receiver 5 that is coupled to the non-emergency drop cord plug 10 (not shown).

FIG. 3a shows the fastener 4 with two prongs that slip under the fastener receiver 5. A fastener guide 16 shown is configured to guide the prongs of the fastener into position whereby they positively engage the fastener receiver 5. The fastening mechanism can vary between cable/cord plugs and PTS 3 embodiments. Nonetheless, common to all fasteners is the need to include exerting physical force to at least mechanically engage or disengage a cord or a plug from the PTS 3. In some embodiments, a visual and/or an audio confirmation can validate positive engagement. Furthermore, in at least one embodiment, the phase/s that is/are under load can be the last pin contact to electrically engage.

The present figure shows five conductors 2 extending above the PTS drop cable 13 and three conductors 2 extending below both the integrated emergency PTS cable 17 and the PTS emergency cord 7. Of the five conductors 2 above a single conductor is a common ground conductor to both the integrated emergency PTS cable 17 and the PTS emergency cord 6. The other two conductors shown extending out from the integrated emergency cable 17 include an emergency circuit power conductor with a dedicated neutral conductor. The other two conductors shown extending out from non-emergency cord 7 include an emergency circuit power conductor with a dedicated neutral conductor.

FIG. 3b is an enlarged view that shows a PTS drop cable 13 coupled to the PTS 3 from above. An integrated non-emergency PTS cable 18 is shown coupled to the PTS 3 from below. From the side, an emergency drop cable 9 with a non-emergency drop cable plug 9 is shown coupled to the PTS 3. At least one emergency drop cable plug 9 can have a fastener 4 coupled. This fastener can be configured to mechanically engage a reciprocating fastener receiver 5 that is coupled to the PTS 3. In at least one different embodiment, at least one fastener 4 can be coupled to the body of the PTS 3 and can be configured to mechanically engage at least one fastener receiver 5 that is coupled to the emergency drop cable plug 9 (not shown).

FIG. 3b shows the fastener 4 with two prongs that slip under the fastener receiver 5. A fastener guide 16 shown is configured to guide the prongs of the fastener into position whereby they positively engage the fastener receiver 5. The fastening mechanism can vary between cable/cord plugs and PTS 3 embodiments. Nonetheless, common to all fasteners 4 is the need to exert physical force to at least mechanically engage or disengage a cord plug 10 or a cable plug 9 to/from the PTS 3. In some embodiments, a visual and/or an audio confirmation can validate positive plug 9, 10 engagement. Furthermore, in at least one embodiment, the last conductor pin of a plug 9, 10 to be electrically engaged by the power conveying PTS 3 is the conductor pin that conveys power.

FIG. 3b shows five conductors 2 extending above the PTS drop cable 13 and three conductors 2 extending below both the integrated non-emergency PTS cord 18 and the PTS emergency cable 6. Of the five conductors 2 above, a single conductor is a common ground conductor to both the integrated non-emergency PTS cord 18 and the PTS emergency cable 6. The other two conductors shown extending out from the integrated non-emergency cord 18 include a non-emergency circuit power conductor and a dedicated neutral conductor. The other two conductors shown extending out from the emergency cable 6 include an emergency circuit power conductor and a dedicated neutral conductor.

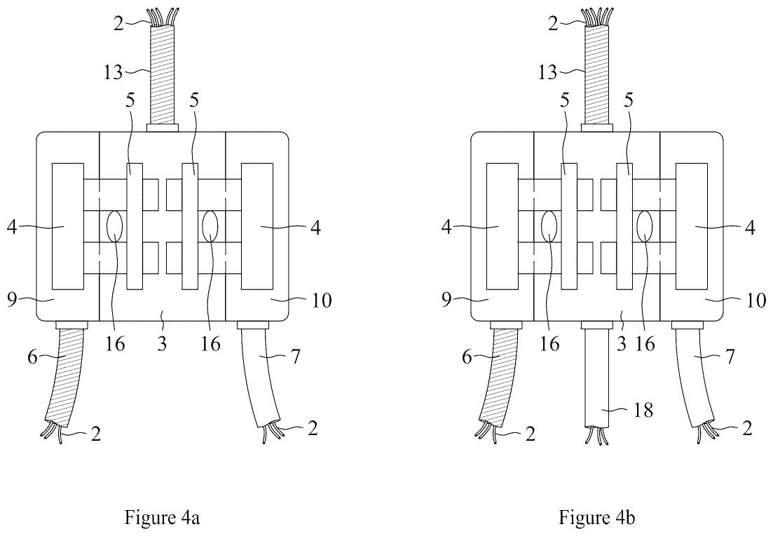

FIGS. 4a and 4b show enlarged views of the PTS including a PTS with a double-sided plug connectivity and a PTS with a double-sided plug connectivity and an integrated drop cable.

FIG. 4a shows an elongated view of a PTS 3 with double-sided connectivity. Five conductors 2 shown extending out of and above the PTS drop cable 13 convey power to the PTS 3. On one side of the PTS 3 emergency power drop cable 6 with emergency drop cable plug 9 is shown coupled to the PTS 3. At least one of the three conductors extending below the emergency power drop cable 6 is configured to deliver emergency power to at least one light emitting device coupled (not shown).

At the other side of the present PTS 3 embodiment shown, a non-emergency power drop cord 7 with non-emergency drop cord plug 10 is shown coupled to the PTS 3. At least one of the three conductors extending below the emergency power drop cord 7 is configured to deliver non-emergency power to at least one light emitting device coupled (not shown).

Both the PTS emergency drop cable plug 9 and the non-emergency drop cord plug 10 are shown mechanically coupled to the PTS 3 by fasteners 4. The fastening assembly can include at least one of, a fastener 4, a fastener receiver 5, and a fastener guide 16. At least two elements of the stated assembly can be coupled to at least one side of the coupled PTS 3 and plug 9, 10 assembly. The present power distribution configuration of the present figure is the same as shown in FIGS. 3a and 3b.

FIG. 4b shows an elongated view of a PTS 3 with double-sided connectivity. Six conductors 2 shown extending out of and above the PTS drop cable 13 convey power to the PTS 3. The present figure of the PTS 3 shows an integrated non-emergency PTS cord 18 extending downward with three conductors extending from inside the cord 18. In at least one different embodiment, an integrated emergency PTS cable 17 can couple to the PTS 3.

The power distribution within the PTS 3 that receive six conductors 2 can be divided as follows:

With an assembly having two cables conveying emergency power and one cord or cable conveying non-emergency house power, each of the emergency power conveying cables can have a different power circuit conductor with a dedicated neutral conductor and each share a common ground conductor that couple to the ground conductor inside the PTS 3 originating from the PTS drop cable 13. The non-emergency power cord or cable can have yet another power circuit conductor with a dedicated neutral conductor and a ground conductor that also couples to the ground conductor inside the PTS 3. The ground conductor of the present assembly couples to the ground conductor of the PTS drop cable 13.

With an assembly having at least one of a cord and/or a cable conveying non-emergency power and one cable conveying emergency power, each of the non-emergency power conveying cords and/or cables can have the same or a different power circuit conductor with at least one dedicated neutral conductor and each can share a common ground conductor that couples to the ground conductor inside the PTS 3. The ground conductor of the present assembly couples to the ground conductor of the PTS drop cable 13. The emergency power cable can have another power circuit conductor with a dedicated neutral conductor. The ground conductor of the present cable conveying the emergency power also couple to the ground conductor of the PTS drop cable 13.

The present power distribution configuration of FIG. 4b is similar to the power distribution configuration as shown for FIG. 4a with the coupled integrated drop cable or cord 17, 18 and an at least one six conductor 2 power distribution configuration.

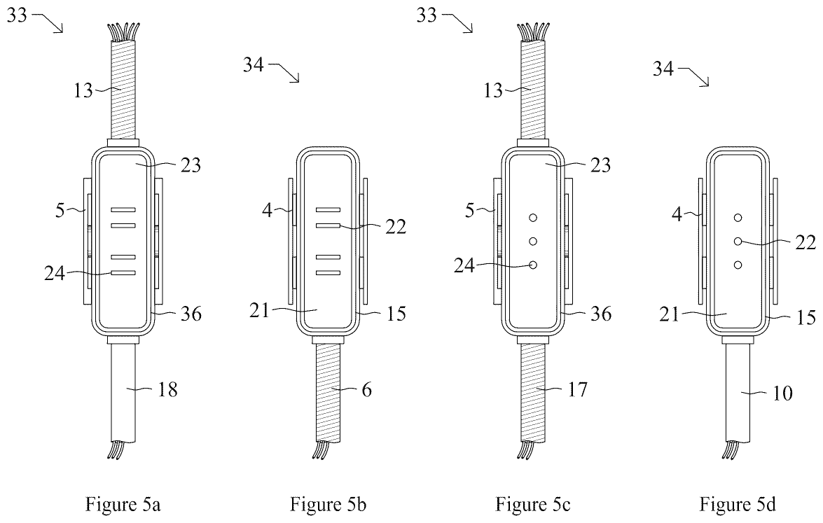

FIGS. 5a, 5b, 5c, and 5d show the PTS and reciprocating cable plug and cord plug means of electrical connectivity.

FIG. 5a shows a view of a PTS connector 33. The PTS connector 33 is shown coupled from above to a PTS drop cable 13. An integrated non-emergency PTS drop cord 18 is shown coupled to the PTS connector 33 from below. At least one surface of the PTS connector 33 is configured to receive pinned plug conductors and is referred to herein as the female plug receptacle surface 23. Pin openings 24 on the female plug receptacle surface 23 shown are configured to receive reciprocating plug pins to establish electrical connectivity with electrical conductors embedded inside the PTS 3.

FIG. 5a shows a PTS connector recess 36 that is configured to receive at least a portion of a PTS' connector protrusion 15 that is coupled to the PTS' cable plug 9. A different embodiment of a PTS connector 33 can employ other means of pairing the PTS' cable plugs 9 to the PTS connector 33. These means of pairing are aimed to at least provide one of an electrical alignment between electrical pinned conductors, closure of physical gaps where one can touch a conductor under load and, prevent exposing the power conveying conductors to moisture. These provisions for the electrical connectivity can stand on their own or, in part or whole, and can be incorporated with the mechanical fastener receiver 5 and/or with its corresponding fastener 4 assembly.

It is noted that at least one of the pin openings 24 shown on the surface of the female receptacle 23 is/are keyed configured to discriminate against any plug pin that is non-compatible. The paired PTS connector 33 with a PTS cord or PTS cable plug 9, 10 connectivity requires at least one voltage compatibility, electrical keyed pins/pin opening compatibility, and mechanically fastener/fastener receiver compatibility.

The present example of the PTS connector 33 shows four pin openings 24 on the surface of the female plug receptacle 23. The number of the pin openings 24 is indicative of the number of circuits conveyed to the cord plug or cable plug 9, 10 coupled. The number of pin openings 24 of the present exemplary figure shows two openings dedicated to two separate power circuits pins, one opening for a common neutral pin, and one opening for a common ground pin.

It is noted that aside from the number of pin openings 24, the openings can vary by opening form, depth to contact, arrangement across the female plug receptacle surface 23, the surface profile of the female plug receptacle surface 23, and most importantly, the type of power the conveyed. The emergency conveying PTS connector 33 can be configured to have different keyed connectivity than a non-emergency PTS connector 33.

FIG. 5b shows a PTS plug connector 34 that is configured to couple to the PTS connector 33 shown in FIG. 5a. The present figure shows a PTS emergency power drop cable 6 coupled from below to the PTS plug connector 34. It is noted that both emergency and non-emergency conductors can be conveyed in armored cable 6 as shown; however, for cost savings reasons, non-emergency conductors are typically conveyed inside cords that do not provide at least one of an armored protection and extended duration fire rating. The present figure shows four conductor pins 22 protruding from the male plug receptacle surface 21 of a PTS emergency power cable 6. Other elements shown include the PTS connector protrusion 15, and mechanical fasteners 4 positioned at opposite sides of the PTS plug connector 34.

FIG. 5c shows a view of a PTS connector 33. The PTS connector 33 is shown coupled from above to a PTS drop cable 13. An integrated emergency PTS cable 17 is shown coupled to the PTS connector 33 from below. At least one surface of the PTS connector 33 is configured to receive pinned plug conductors and is referred to herein as the female plug receptacle surface 23. Pin openings 24 in the female plug receptacle surface 23 shown are configured to receive reciprocating plug pins to establish electrical connectivity with electrical conductors embedded inside the PTS 3.

FIG. 5c shows a PTS connector recess 36 that is configured to receive at least a portion of a PTS connector protrusion 15 that is coupled to a PTS' integrated PTS emergency cable 6, 17. A different embodiment of a PTS connector 33 can employ other means of pairing the PTS' cable 6, 17 to the PTS connector 33. These means of pairing are aimed to at least provide one of an electrical alignment between electrical pinned conductors, closure of physical gaps where one can touch a conductor under load and, prevent exposing the power conveying conductors to moisture. These provisions for the electrical connectivity can stand on their own or, in part or whole, can be incorporated with the mechanical fastener receiver 5 and with its corresponding fastener 4 assembly.

It is noted that at least one of the pin openings 24 shown on the surface of the female receptacle 23 is/are keyed configured to discriminate against any plug pin that is non-compatible. The paired PTS connector 33 with a PTS cord plug 10 connectivity requires at least one voltage compatibility, electrical keyed pins/pin opening compatibility, and mechanically fastener/fastener receiver compatibility.

The present example of the PTS connector 33 shows three pin openings 24 in the surface of the female plug receptacle 23. The number of the pin openings 24 is indicative on the number of circuits conveyed to the PTS cord plugs 10 coupled. The number of pin openings 24 of the present exemplary figure show one opening dedicated to a power circuits pin, one opening for a neutral conductor pin, and one opening for a ground conductor pin. It is noted that at least one of a ground conductor and a neutral conductor can each be common to other power conductor/s circuits.

It is also noted that aside from the number of pin openings 24, the openings can vary by opening form, depth to contact, arrangement across the female plug receptacle surface 23, the surface profile of the female plug receptacle surface 23 and most importantly, the type of power the conveyed. The emergency conveying PTS connector 33 can be configured to have different keyed connectivity than a non-emergency PTS connector 33.

FIG. 5d shows a PTS plug connector 34 that is configured to couple to the PTS connector 33 shown in FIG. 5c. The present figure shows a PTS emergency power drop cord 7 coupled from below to the PTS plug connector 34. It is noted that only non-emergency conductors can be conveyed in a PTS non-emergency drop cord 7 as shown. While armored cable drop cords are allowable by code, for cost savings reasons, non-emergency conductors typically are conveyed inside cords. Code does not require that the non-emergency cord provide at least one of an armored protection and extended duration fire rating. The present figure shows three conductor pins 22 protruding from the male plug receptacle surface 21 of a PTS emergency power cable 6. Other elements shown include the PTS connector protrusion 15, and mechanical fasteners 4 positioned at opposite sides of the PTS plug connector 34.

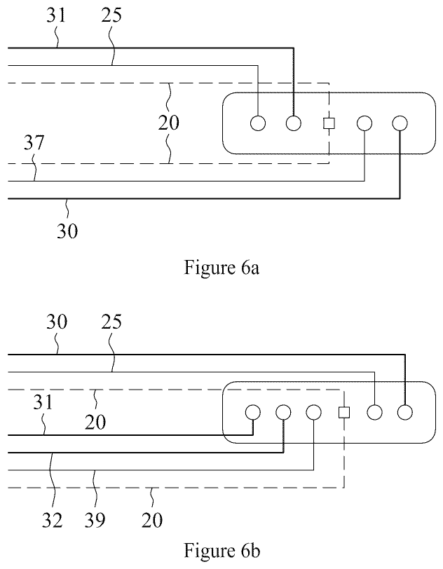

FIGS. 6a and 6b show exemplary PTS 3 configured to convey two and three power circuits to a downstream device, respectively.

FIG. 6a shows a two-circuit diagram of the PTS 3. The PTS drop cable coupled to the PTS 3 of the present figure delivers at least five conductors. The conductors include two power circuit conductors 30,31, two neutral conductors 25, 37 wherein neutral conductor 25 is dedicated to a power circuit conductor 31, and a neutral conductor 37 is dedicated to power circuit conductor 30, and a ground conductor 20 that is a shared common conductor with the power circuit conductors.

The power distribution diagram of FIG. 6a is applicable to settings where the PTS 3 is tasked with power conveyance to at least one emergency power consuming device and at least one non-emergency power consuming device. Power received and distributed through the PTS 3 can then reach a coupled device through cables and cords as shown in FIGS. 3a and 3b and in FIG. 4a.

FIG. 6b shows a three-circuit diagram of the PTS 3. The PTS drop cable coupled to the PTS 3 of the present figure delivers at least six conductors. The conductors include three power circuit conductors 30, 31, 32, two neutral conductors wherein one neutral conductor 25 is dedicated to power conductor 30 and the other neutral conductor 39 is common to power circuits conductors 31, 32, and a neutral conductor that is a shared common conductor with all three power circuit conductors 30, 31, 32.

The power distribution diagram of FIG. 6b is applicable to settings where the PTS 3 can be tasked with power conveyance to at least two emergency power consuming devices that operate differently from one another and at least one non-emergency power consuming device. Power received and distributed through the PTS 3 can then reach a coupled device through cables and cords as shown in FIG. 4b. For example, the two circuits conveying power to a building illuminated means of egress can include a requirement to power at least one illuminated egress sign and at least one illuminated egress path luminaire. The power conveyed by the first emergency power circuit to the egress sign can be on continuously. The power conveyed by the second power circuit can power the egress path luminaire only when house power is interrupted. The third power circuit can be configured to power a non-emergency powered power consuming device.

Similarly, the present power distribution configuration can be switched where only one power conductor is used for emergency power consuming device/s while the other two power circuit conductors can power at least two different non-emergency power consuming devices.

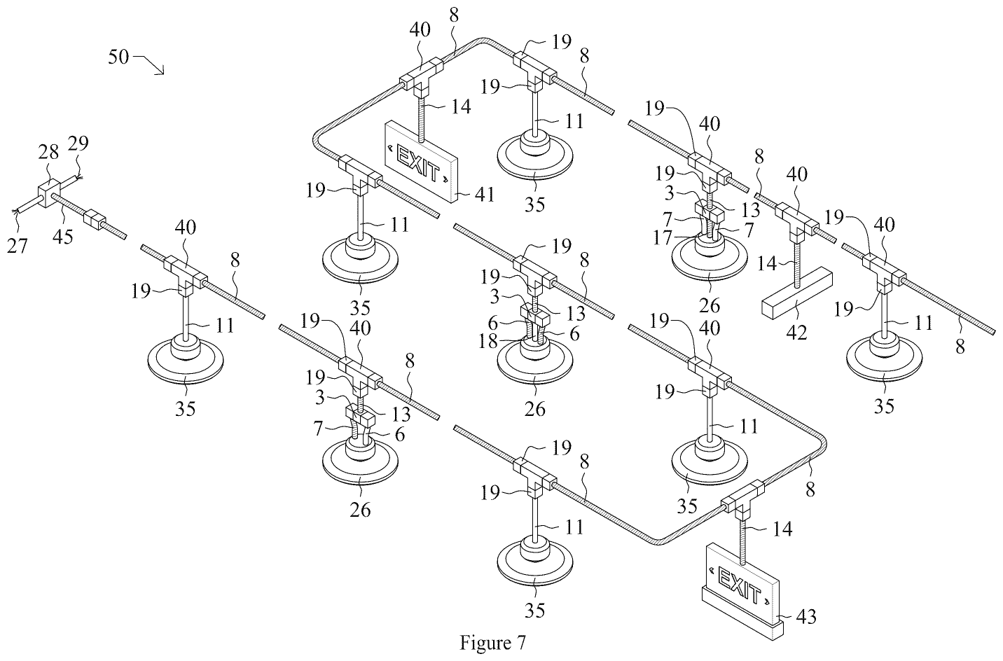

FIG. 7 shows a perspective view of an assembly of light emitting devices electrically coupled by modular wiring with circuits conveying emergency and non-emergency power.

The present figure shows an input power conduit 27 flowing power through a power/data box 28 to power conduit 29 conveying at least one power conductor inside to at least one power consuming device downstream. A modular wiring starter cable 45 with at least one power conductor inside is shown coupled to the power/data box 28. The starter cable 45 conveys power to at least two power consuming devices downstream. The power consuming devices shown are light emitting devices 26, 35 that are electrically coupled by an extender cable 8.

The light emitting device 35 does not show a PTS 3 element, inferring that the light emitting device consumes non-emergency power. For this reason a drop cord 11 with its connector 19 is shown electrically coupling the light emitting device 35 to a phase splitter 40.

The emergency/ambient light emitting device 26 shown displays different PTS 3 power connectivity configurations. The first emergency/ambient light emitting device 26 downstream from the power/data box 28 shows a PTS emergency drop cable 6 and a non-emergency drop cord 7 extending down from the PTS 3 and coupling to the emergency/ambient light emitting device 26 below.

The second emergency/ambient light emitting device 26 downstream from the power/data box 28 show two PTS emergency drop cables 6 and one integrated non-emergency drop cord 18 extending down from the PTS 3 and coupling to the emergency/ambient light emitting device 26 below.

The third emergency/ambient light emitting device 26 downstream from the power/data box 28 show two PTS non-emergency drop cords 7 and one integrated emergency drop cable 17 extending down from the PTS 3 and coupling to the emergency/ambient light emitting device 26 below.

The present modular wiring system figure also shows an exit fixture 41, a stand-alone egress light source 42, and an exit combo unit 43 coupled. At least one circuit flowing power to the emergency/ambient light emitting device 26 can flow power to a stand-alone emergency egress light source 42 and/or to an exit combo unit 43. Another emergency circuit can flow constant power to at least one of the exit sign 41 and the exit combo unit 43.

As shown, the present modular wiring assembly is configured to convey power through at least one of a starter cable 45, phase splitter 40, an extender cable 8, a drop cable 13, a drop cord 11, a PTS emergency drop cable 6, and a non-emergency drop cord/cable 7, to at least one of a light emitting device 35, an emergency/ambient light emitting device 26 an exit combo unit 43, and an exit sign 41. The present modular wiring assembly as shown employs at least six conductors. The number of conductors inside the modular wiring system can vary and at least one conductor can be configured to convey data.

Element List

| | | | |
|---|---|---|---|
| 1. | Armored Cable | 2. | Conductor |
| 3. | Power Type Splitter (PTS) | 4. | Fastener |
| 5. | Fastener Receiver | 6. | PTS Emergency Power Drop Cable |
| 7. | PTS Non-emergency Power Drop Cable/Cord | 8. | Extender Cable |
| 9. | Emergency Drop Cable Plug | 10. | Non-emergency Drop Cable/Cord Plug |
| 11. | Drop Cord | 12. | Power Source |
| 13. | PTS Drop Cable | 14. | Drop Cable |
| 15. | PTS Connector Protrusion | 16. | Fastener Guide |
| 17. | Integrated Emergency PTS Cable | 18. | Integrated Non-emergency PTS Cable/Cord |
| 19. | Connector | 20. | Ground Conductor |
| 21. | Male Plug Receptacle Surface | 22. | Conductor Pin |
| 23. | Female Plug Receptacle Surface | 24. | Pin Opening |
| 25. | First Phase Neutral Conductor | 26. | Emergency/Ambient Light Emitting Device |
| 27. | Up-stream Conduit | 28. | Power/Data Distribution Box |
| 29. | Down-stream Conduit | 30. | First Phase Conductor |
| 31. | Second Phase Conductor | 32. | Third Phase Conductor |
| 33. | PTS Connector | 34. | PTS Plug Connector |
| 35. | Light Emitting Device | 36. | PTS Connector Recess |
| 37. | Second Phase Neutral Conductor | 39. | Common Neutral Conductor |
| 40. | Phase Splitter | 41. | Exit Sign |
| 42. | Stand-alone Egress light Source | 43. | Exit Combo Unit |
| 45. | Starter Cable | | |

1. A modular wiring assembly comprising:
a first conductor configured to convey power to an illuminated emergency means of egress of a building;
a second conductor configured to convey power to a non-emergency power consuming device;
a starter cable having a connector coupled at one end thereof;
an extender cable coupled to connectors or an extender cable with an integrated phase splitter at one end and a connector at the other end;
a power type splitter;
a power type splitter drop cable coupled to a connector; and
a power type splitter emergency drop cable with a plug at an end thereof; and
a power type splitter non-emergency cord or cable with a plug at an end thereof, wherein
the connector of the power type splitter coupled drop cable is coupled to at least one of an extender cable connector or a phase splitter,
the power type splitter has at least one keyed connector that is configured to couple to at least one of the power type splitter emergency power drop cable or the power type splitter non-emergency power drop cord or cable, the plug of the power type splitter emergency power drop cable and the plug of power type splitter non-emergency power cord or cable that connect to the power type splitter are keyed differently from one another,
conductors of the power type splitter drop cable include
at least one of a first power circuit conductor, a first circuit dedicated neutral conductor, and a ground conductor, and
at least one of a second power circuit, a dedicated second circuit neutral conductor, and a ground conductor, and
conductors inside the power type splitter power drop cable that convey emergency power to the emergency/ambient light emitting device and conductors inside the power type splitter drop cable that convey non-emergency power to the emergency/ambient light emitting device share a common ground conductor.

2. The modular wiring assembly of claim 1, wherein
the power type splitter emergency power drop cable conveys emergency power and the at power drop cord conveys non-emergency power convey power to an emergency/ambient light emitting device through different dedicated ports that are set apart from one another.

3. The modular wiring assembly of claim 1, further comprising:
an integrated emergency power type splitter cable that couples to the power type splitter, and
a non-emergency drop cable or cord plug couples to the power type splitter.

4. The modular wiring assembly of claim 1, further comprising:
an integrated non-emergency power type splitter cord or cable couples to the power type splitter, and an emergency drop cable plug couples to the power type splitter.

5. The modular wiring assembly of claim 1, wherein at least one of an emergency drop cable plug and a non-emergency drop cable cord of the power type splitter include pin openings configured to receive opposing conductor pins of a mating plug.

6. The modular wiring assembly of claim 1, wherein the power type splitter includes a female plug receptacle having keyed pin openings configured to couple with a mating plug of the power type splitter emergency drop cable or the power type splitter non-emergency drop cable plug or drop cable cord, the keyed pin openings are discriminately configured for at least one of emergency power only and a specific voltage range.

7. The modular wiring assembly of claim 1, wherein at least one of pin opening numbers, a surface color, a keyed connector form, and a keyed opening configuration of a power type splitter conveying emergency power to an emergency power consuming device is different than one of pin opening numbers, a surface color, a keyed connector form, and a keyed opening configuration of a same power type splitter conveying non-emergency power to a power consuming device.

8. A modular wiring assembly comprising:
a first conductor configured to convey power to an illuminated emergency means of egress of a building;
a second conductor configured to convey power to a non-emergency power consuming device;
a starter cable having a connector coupled at one end thereof;
an extender cable coupled to connectors or an extender cable with an integrated phase splitter at one end and a connector at the other end;
a power type splitter;
a power type splitter drop cable coupled to a connector; and
a power type splitter emergency drop cable with a plug at an end thereof; and
a power type splitter non-emergency cord or cable with a plug at an end thereof, wherein
the connector of the power type splitter coupled drop cable is coupled to at least one of an extender cable connector or a phase splitter,
the power type splitter has at least one keyed connector that is configured to couple to at least one of the power type splitter emergency power drop cable or the power type splitter non-emergency power drop cord or cable, the plug of the power type splitter emergency power drop cable and the plug of power type splitter non-emergency power cord or cable that connect to the power type splitter are keyed differently from one another, wherein
emergency power conveyed through the power type splitter emergency power drop cable to an emergency/ambient light emitting device powers at least one emergency light source,
non-emergency power conveyed through the power type splitter non-emergency power drop cord coupled to the emergency/ambient light emitting device powers at least one non-emergency device that is coupled to the emergency/ambient light emitting device, and
the power type splitter power drop cable that conveys emergency power and the power type splitter power drop cord that conveys non-emergency power couple to the emergency/ambient light emitting device through different ports that are set apart from one another.

9. The modular wiring system of claim 8, wherein sets of conductors of the power type splitter emergency power drop cable and the power type splitter non-emergency power drop cord/cable share a common ground conductor inside the power type splitter.

10. The modular wiring system of claim 8, wherein at least two surfaces of the power type splitter can couple to at least one of the emergency power drop cable and the non-emergency drop cable/cord.

11. The modular wiring system of claim 8, wherein the power type splitter is configured to split power of a circuit among at least two power type splitter drop cables and/or power type drop cords.

12. The modular wiring system of claim 8, further comprising keyed connectors that prevent inadvertent coupling on an emergency power connector with a non-emergency power connector.

13. The modular wiring system of claim 12, wherein the keyed connectors prevent coupling of connectors that covey different voltages.

14. The modular wiring system of claim 8, further comprising at least one mechanical fastener and/or a mechanical fastener receiver that is configured to prevent the disconnection of a coupled cable or cord plug from the power type splitter.

15. A modular wiring assembly comprising:
a first conductor configured to convey power to an illuminated emergency means of egress of a building;
a second conductor configured to convey power to a non-emergency power consuming device;
a starter cable having a connector coupled at one end thereof;
an extender cable coupled to connectors or an extender cable with an integrated phase splitter at one end and a connector at the other end;
a power type splitter;
a power type splitter drop cable coupled to a connector; and
a power type splitter emergency drop cable with a plug at an end thereof; and
a power type splitter non-emergency cord or cable with a plug at an end thereof, wherein
the connector of the power type splitter coupled drop cable is coupled to at least one of an extender cable connector or a phase splitter,
the power type splitter has at least one keyed connector that is configured to couple to at least one of the power type splitter emergency power drop cable or the power type splitter non-emergency power drop cord or cable, the plug of the power type splitter emergency power drop cable and the plug of power type splitter non-emergency power cord or cable that connect to the power type splitter are keyed differently from one another, wherein
conductors of the power type splitter drop cable include
at least one first power circuit conductor for a first power circuit and at least one second power circuit conductor for a second power circuit and a common neutral and a common ground conductor,
conductors of the power type splitter drop cord include at least conductors for a third power circuit that has a dedicated neutral conductor and a dedicated ground conductor, and
the common ground conductor of the first and second power circuits and the ground conductor of the third circuit couple to a common ground conductor inside the power type splitter.

16. The modular wiring assembly of claim 15, wherein power inside the power type splitter is divided among at least two output ports that convey at least one of emergency power and non-emergency power to a power consuming device.

17. The modular wiring assembly of claim 15, wherein the power type splitter comprises at least one mechanical fastener and/or a mechanical fastener receiver configured to prevent disconnection of at least one coupled PTS cable or PTS cord plug.

18. The modular wiring assembly of claim 15, wherein at least one exterior surface of a component of the modular wiring assembly that conveys emergency power to a building means of illuminated egress is colored differently from other components of the modular wiring assembly.

19. The modular wiring assembly of claim 15, wherein at least one of the first and second power circuit conductors comprise pins that conveying power downstream, the pins electrically engage inside a pin opening of power type splitter pin opening to provide an electrical connection during power flow, and when disengaged, power flow is broken.

20. The modular wiring assembly of claim 15, wherein at least one first power circuit powers an exit sign, one second power circuit powers an egress light source, and one third power circuit powers an ambient lighting luminaire.
